(19) United States
(12) Patent Application Publication
(10) Pub. No.: US 2003/0056003 A1
(43) Pub. Date: Mar. 20, 2003

(54) Internet broadcast and location tracking method and apparatus

(76) Inventor: Bryce Nakatani, Fallbrook, CA (US)

Correspondence Address: James Y. Sze, Pillsbury Winthrop, 11682 El Camino Real,, Suite 200, San Diego, CA, 93102, US

(21) Appl. No.: 09/956,452

(22) Filed: Sep. 18, 2001

(51) Int. Cl. G06F 15/173

(52) U.S. Cl. 709/238; 709/249

(57) ABSTRACT

A control method, apparatus, and system capable of finding the location of an intended recipient with an audio/video broadcast, and then enabling a point-to-point reply between the intended recipient and an initiating party. In one embodiment, a broadcast source broadcasts an audio, visual or multimedia message to all machines on a network. A receiving machine plays the message and a receiving party hears, sees or otherwise becomes aware of the broadcast message. The receiving party may then prompt the receiving machine to then resolve the broadcast source, and send a reply to the broadcast source, opening a point-to-point communication with the broadcast source.

### BACKGROUND

1. Field of the Invention

Aspects of the present invention relate in general to a system to broadcast audio/video signals, and to enable point-to-point communication with an intended recipient. The system, method and apparatus enable communication through locating an intended recipient through an audio/video broadcast, and then enabling a point-to-point reply.

1. Description of the Related Art

Conventionally, intercom equipment provides its users the ability to broadcast audio messages throughout a network. That is to say, each intercom on the network receives and relays an audio message broadcast from one intercom to all the remaining intercoms on the network. In many cases, it is inconvenient or problematic to conduct a private conversation because of the broadcast nature of intercom equipment. A point-to-point method, such as a land-line or wireless phone may be used instead of an intercom.

When repairing or maintaining networked monitoring and/or control equipment, traditionally field technicians frequently carry a wireless phone to communicate with other field technicians diagnosing a problem on the same network. This is a waste of resources, as both technicians are already located near machines on the same network.

### BRIEF DESCRIPTION OF THE DRAWINGS

FIG. 1 illustrates an embodiment of a system to broadcast audio/video signals, and to enable point-to-point communication with an intended recipient.

FIG. 2 is a block diagram of an embodiment of an apparatus to broadcast audio/video signals, and to enable point-to-point communication with an intended recipient.

FIG. 3 is a block diagram of an alternate embodiment of an apparatus to broadcast audio/video signals, and to enable point-to-point communication with an intended recipient.

FIG. 4 is a block diagram of a brain module of the embodiment shown FIG. 3.

FIG. 5 is a block diagram of another alternate embodiment of an apparatus to broadcast audio/video signals, and to enable point-to-point communication with an intended recipient.

FIG. 6 is an expanded block diagram of an apparatus to broadcast audio/video signals, and to enable point-to-point communication with an intended recipient.

FIG. 7 is a diagram of an interface to facilitate the broadcast of audio/video signals, and to facilitate the point-to-point communication with an intended recipient.

FIG. 8 is a diagram of an alternate interface to facilitate the broadcast of audio/video signals, and to facilitate point-to-point communication with an intended recipient.

FIG. 9 is a diagram of a basic packet structure to facilitate the broadcast audio/video signals, and to facilitate the point-to-point communication with an intended recipient.

FIGS. 10A-10B are sequence diagrams of a general flow to broadcast audio/video signals, and to enable point-to-point communication with an intended recipient.

FIG. 11 is a flowchart of a method to broadcast audio/video signals, and to enable point-to-point communication with an intended recipient.

FIG. 12 is a flowchart of a method to receive broadcast audio/video signals, and to enable point-to-point communication from an intended recipient.

### DETAILED DESCRIPTION

What is needed is an easy-to-use system, apparatus and method to broadcast audio/video signals, and to enable point-to-point communication with an intended recipient.

Aspects of the present invention include a system, method and apparatus that facilitates communication through locating an intended recipient with an audio/video broadcast, and then enabling a point-to-point reply between the intended recipient and an initiating party. In one embodiment, a broadcast source broadcasts an audio, visual or multimedia message to all machines on the network. A receiving machine plays the message and a receiving party hears, sees or otherwise becomes aware of the broadcast message. The receiving party may then prompt the receiving machine to then resolve the broadcast source, and send a reply to the broadcast source, opening a point-to-point communication with the broadcast source. Embodiments of the invention include, but are not limited to, generic computing and communications devices that perform an embodied method, an intercom device, a programmable logic controller (PLC) adapted to perform the embodied method, an intercom system, or an intercom adapter card to be fitted into another device.

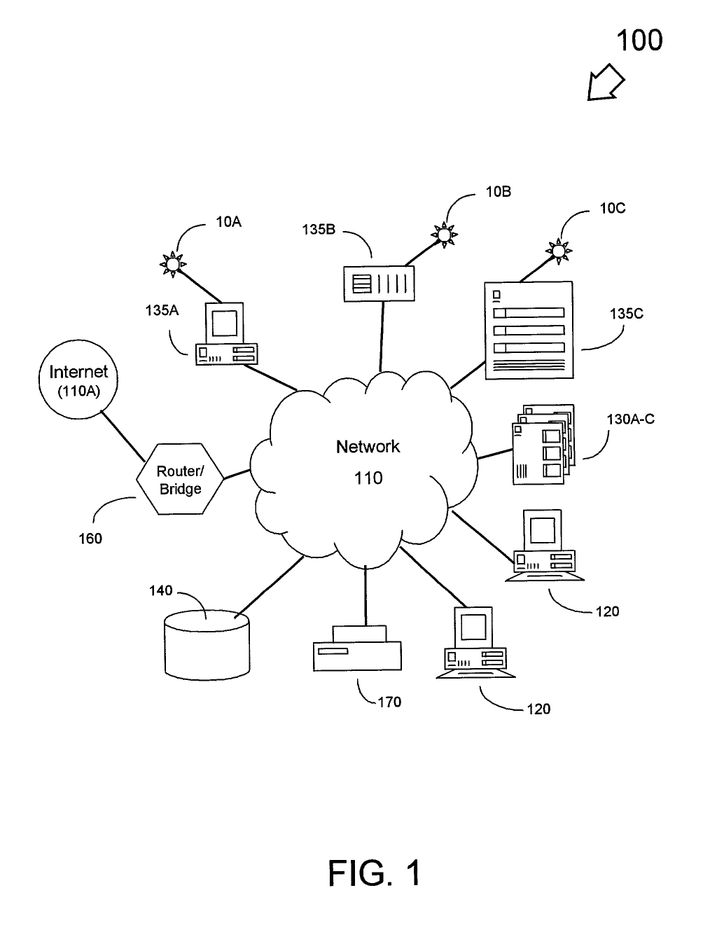

FIG. 1 is a simplified functional act diagram depicting system 100, constructed and operative in accordance with an embodiment of the present invention. System 100 is configured to broadcast audio/video signals, and to enable point-to-point communication with an intended recipient.

An embodiment of the method broadcasts an initial message, receives a point-to-point reply message, and opens a point-to-point communications channel through an intercom device 135.

In system 100, remote computers 120 are coupled via a communications network 110. The remote computers 120 may communicate to intercom device 135 via network 110. It is understood by those skilled in the art, that either the remote computers 120 or intercom device 135 may be coupled via a single or multiple number of networks without inventive faculty. Furthermore, the number of computers 120 and intercom devices 135 may vary from system to system.

In some embodiments, intercom device 135 may be a personal computer, personal digital assistant (PDA), wireless phone, an intercom device, a programmable logic controller (PLC) adapted to perform the embodied method, an intercom system, or an intercom adapter card to be fitted into an intercom device or other such network-computing device.

The network 110 may also include other networkable devices known in the art, such as computers 120, storage media 140, other intercom devices 135, servers 130, printers 170, and network devices 160 such as routers or bridges 160. It is well understood in the art, that any number or variety of computer networkable devices or components may be coupled to the network 110 without inventive faculty. Examples of other devices include, but are not limited to, servers, computers, workstations, terminals, input devices, output devices, printers, plotters, routers, bridges, cameras, sensors, or any other such device known in the art.

In one embodiment, intercom device 135 may also function as a monitoring device, or act as a “plug-in” module for a monitoring device. In such embodiments, monitoring device 135 may be any apparatus known in the art that are able to monitor inputs from sensors 10. Sensors are any devices known in the art able to collect input data relevant to a control function. In FIG. 1, three exemplary embodiments of intercom device 135A-C are shown, each connected to at least one sensor 10. It is understood that monitoring device 135 may be coupled to any number of sensors 10.

Network 110 may be any communication network known in the art, including the Internet, a local-area-network (LAN), a wide-area-network (WAN), virtual private network (VPN) or any system that links a computer to an intercom device 135. Further, network 110 may be configured in accordance with any topology known in the art, including star, ring, bus, or any combination thereof.

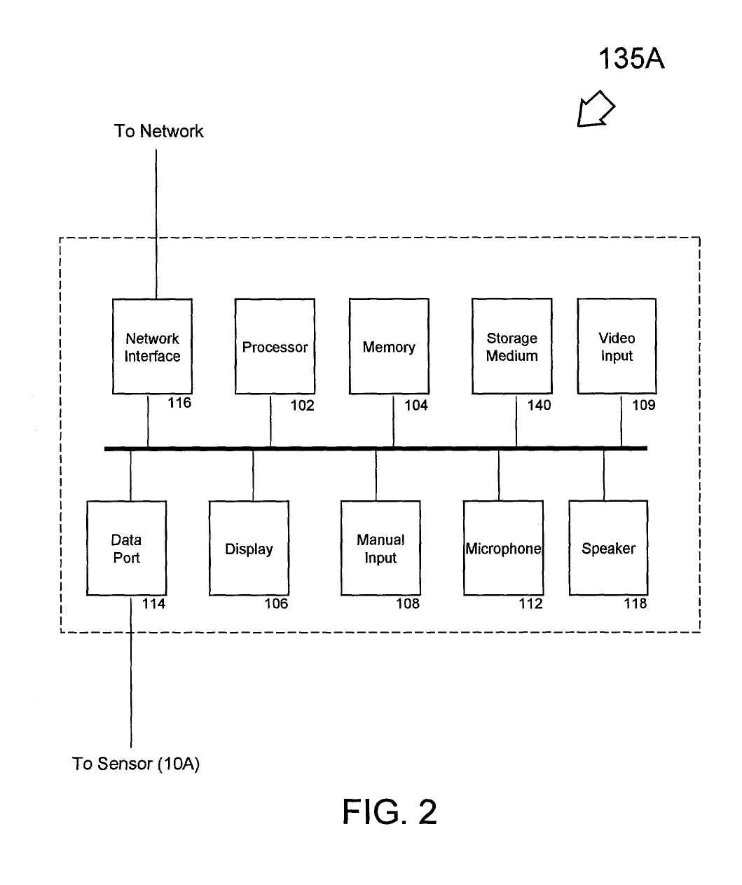

Embodiments will now be disclosed with reference to a block diagram of an exemplary intercom device 135A of FIG. 2, constructed and operative in accordance with an embodiment of the present invention. Intercom device 135 runs a multi-tasking operating system and includes at least one processor or central processing unit (CPU) 102. Processor 102 may be any microprocessor or micro-controller as is known in the art.

The software for programming the processor 102 may be found at a computer-readable storage medium 140 or, alternatively, from another location across network 110 through network interface 116. Processor 102 is coupled to computer memory 104. Intercom device 135 may be controlled by an operating system (OS) that is executed within computer memory 104.

Processor 102 communicates with a plurality of peripheral equipment, including network interface 116, and data port 114. Additional peripheral equipment may include a display 106, manual input device 108, video input 109, storage medium 140, microphone 112, and speaker 118.

Computer memory 104 is any computer-readable memory known in the art. This definition encompasses, but is not limited to: Read Only Memory (ROM), Random Access Memory (RAM), flash memory, Erasable-Programmable Read Only Memory (EPROM), non-volatile random access memory, memory-stick, magnetic disk drive, transistor-based memory or other computer-readable memory devices as is known in the art for storing and retrieving data.

Storage medium 140 may be a conventional read/write memory such as a magnetic disk drive, magneto-optical drive, optical drive, floppy disk drive, compact-disk read-only-memory (CD-ROM) drive, digital video disk read-only-memory (DVD-ROM), digital video disk random-access-memory (DVD-RAM), transistor-based memory or other computer-readable memory device as is known in the art for storing and retrieving data. Storage medium 140 may be remotely located from processor 102, and be coupled to processor 102 via a network 110 such as a local area network (LAN), a wide area network (WAN), or the Internet via network interface 116.

Display 106 may be a visual display such as a cathode ray tube (CRT) monitor, a liquid crystal display (LCD) screen, light emitting diode (LED), touch-sensitive screen, or other monitors as are known in the art for visually displaying images and text to a user.

Manual input devices 108 may be a conventional keyboard, keypad, mouse, trackball, or other input devices as are known in the art for the manual input of data.

Microphone 112 may be any suitable microphone as is known in the art for providing audio signals to processor 102. In addition, a speaker 118 may be attached for reproducing audio signals from processor 102. It is understood that microphone 112, and speaker 118 may include appropriate digital-to-analog and analog-to-digital conversion circuitry as appropriate.

Data port 114 may be any data port as is known in the art for interfacing with an external accessory using a data protocol such as RS-232, Universal Serial Bus (USB), or Institute of Electrical and Electronics Engineers (IEEE) Standard No. 1394 (‘Firewire’). In some embodiments, data port 114 may communicate to external accessories using any interface as known in the art for communicating or transferring files across a computer network. Examples of such networks include Transmission Control Protocol/Internet Protocol (TCP/IP), Ethernet, Fiber Distributed Data Interface (FDDI), ARCNET, token bus, or token ring networks.

In yet other embodiments, intercom I/O interface device 135 may also comprise video input 109. Video input 109 may be any image capture device as is known in the art, such as a video camera.

Network interface 116 is any interface as known in the art for communicating or transferring files across a computer network. Examples of such networks include TCP/IP, Ethernet, FDDI, ARCNET, token bus, or token ring networks.

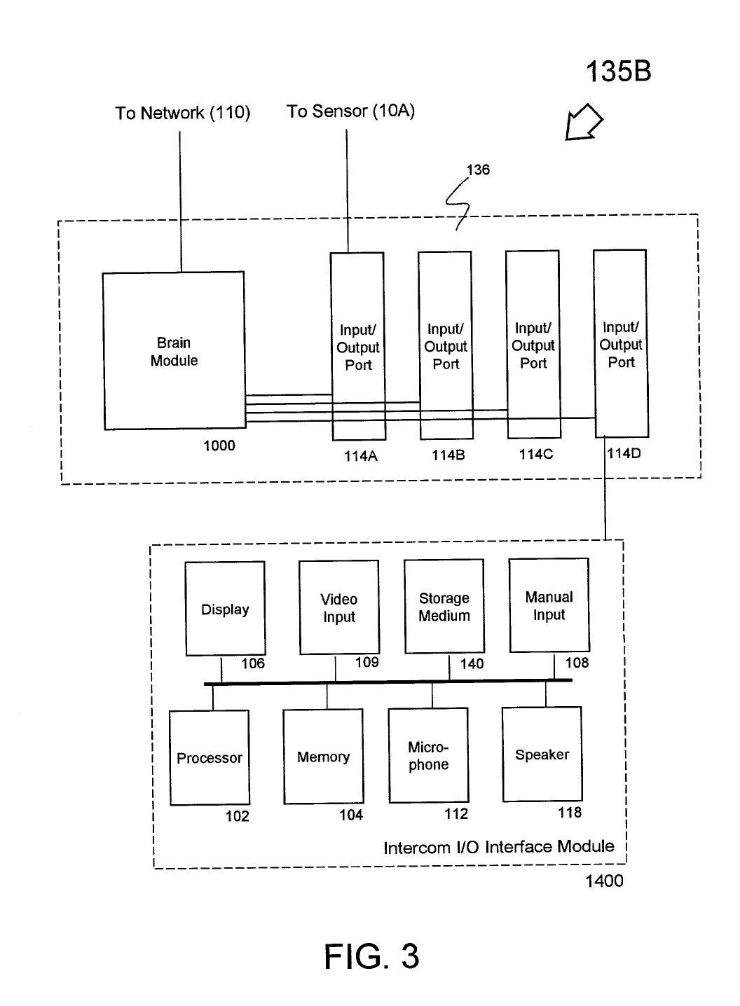

FIG. 3 depicts intercom device 135B, constructed and operative in accordance with an alternate embodiment of the present invention. In this embodiment, intercom device 135 is an input-output monitoring device 136 combined with an intercom I/O interface module 1400. Intercom device 135B comprises a brain module 1000 coupled to at least one input/output port 114. For illustrative purposes only, in FIG. 3, four input/output ports 114A-D are depicted. It is understood that intercom device 135 may have any number of input/output ports 114.

Input/output modules, intercom I/O interface modules 1400, sensors 10, actuators, control modules, like equipment and any other device to be controlled by monitoring device 135B may be plugged into one of the input/output ports 114, to form intercom device 135.

An intercom I/O interface module 1400 is a module to facilitate the broadcast of audio/video signals, and to enable point-to-point communication with an intended recipient, via the monitoring device 136 and network 110. Intercom I/O interface modules 1400 comprise manual input device 108, video input 109, microphone 112, and speaker 118. It is understood that microphone 112 and speaker 118 may contain the appropriate analog-to-digital circuitry and analog-to-digital conversion circuitry as is known in the art. In some embodiments, microphone 112 and speaker 118 may be integrated into a single device. Manual input 108 may be any button, keyboard, mouse, touch tablet or any other form of manual input as is known in the art. In some embodiments, intercom I/O interface modules 1400 may further comprise processor 102, memory 104, and storage medium 140. In yet other embodiments, intercom I/O interface modules 1400 may also comprise video input 109. Video input 109 may be any image capture device as is known in the art, such as a video camera. The use of intercom I/O interface modules 1400 will become clearer as described below.

A brain module 1000 may be any machine intelligence that is able to communicate with the input/output ports 114, and interface the data received with a remote computer 120 over network 110. Brain module 1000 may also execute programs, encoded on computer-readable medium, to execute control functions to manipulate devices, such as sensor 10, coupled to input/output ports 114.

In some embodiments, the interface between brain module 1000 and the input/output ports 114 may be a serial or parallel link. In other embodiments, the interface may be any interface as known in the art for communicating or transferring files across a computer network.

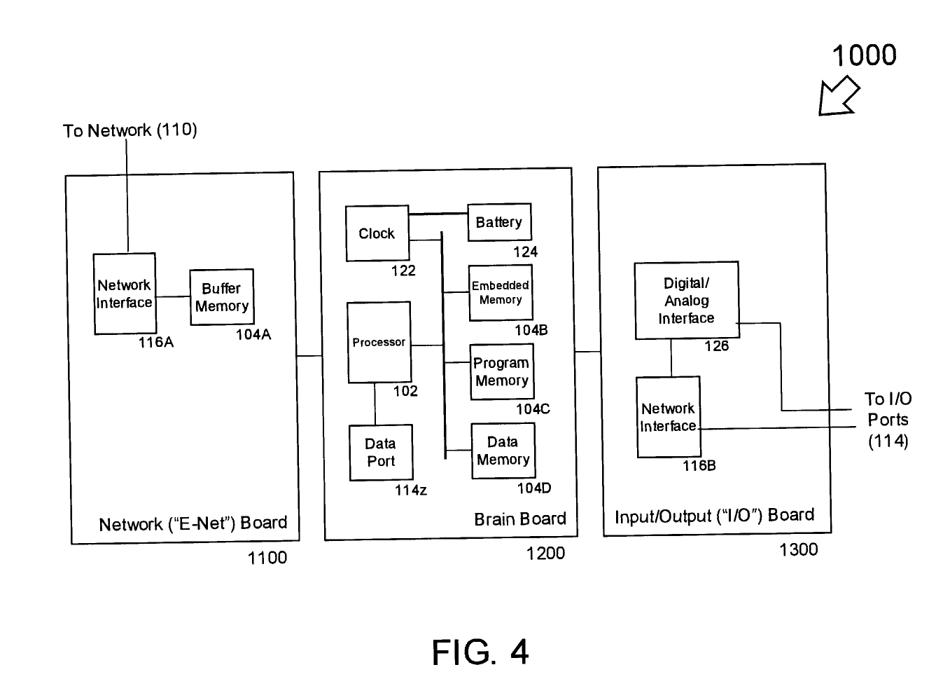

Brain module 1000 is depicted in greater detail in FIG. 4, constructed and operative in accordance with an embodiment of the present invention. As shown, brain module 1000 comprises a network (“e-net”) board 1100, a brain board 1200, and an input/output board (“I/O board”) 1300.

Network board 1100 comprises network interface 116A and buffer memory 104A.

In some embodiments, the components of the three boards 1100 1200 1300 may be combined into a single board or divided differently without altering the scope of the invention. In one embodiment of the present invention, the three boards 1100 1200 1300 are integrated into a single device. As discussed above, network interface 116A may be any interface as known in the art for communicating or transferring files across a computer network. Buffer memory 104A is any computer readable memory used to buffer data being received from or sent to network interface 116 from brain board 1200.

Brain board 1200 is a structure that provides intelligence for intercom device 135, comprising a processor 102 and memory 104. In the embodiment depicted, three different kinds of memory are shown. Embedded memory 104B is memory containing the program structures initially used by intercom device 135. These programs may include the initialization procedures, control programs, or monitoring programs. Program memory 104C is memory dedicated to the execution of computer programs. Data memory 104D is used to store data collected through the monitoring or control of the coupled sensors, actuators, or other monitoring or control devices. In some embodiments, program memory 104C and data memory 104D are combined into a single memory.

As shown, brain board 1200 may also comprise data port 114z, a real time clock 122 and battery 124. Data port 114z provides processor 102 a serial or parallel interface to communicate with diagnostic tools or other equipment. Clock 122 provides brain board 1200 date and time information. To insure the integrity of the date and time information during blackouts, battery 124 provides backup power.

Input/output (“I/O”) board 1300 provides brain board 1200 an interface to the input/output ports 114A-D. Digital/Analog Interface 126 couples to any input/output port 114 and converts any analog signals received (from analog modules) to digital data. Network interface 116B communicates to any input/output port 114 that communicates via a computer networking protocol, as discussed above.

In an alternate embodiment, the intelligence of intercom device 135 may be located in a plug-in module, for example, a programmable logic controller (PLC) embodiment. A programmable logic controller is a ladder-logic controlled device capable of controlling a plurality of attached sensors or control devices. In a programmable logic controller embodiment, or any other a embodiment with limited computing capability, the PLC may not, by itself, have network capability or have the processing throughput to enable network control or monitoring. In such embodiments, a plug-in module may be utilized to provide intelligence and network capability.

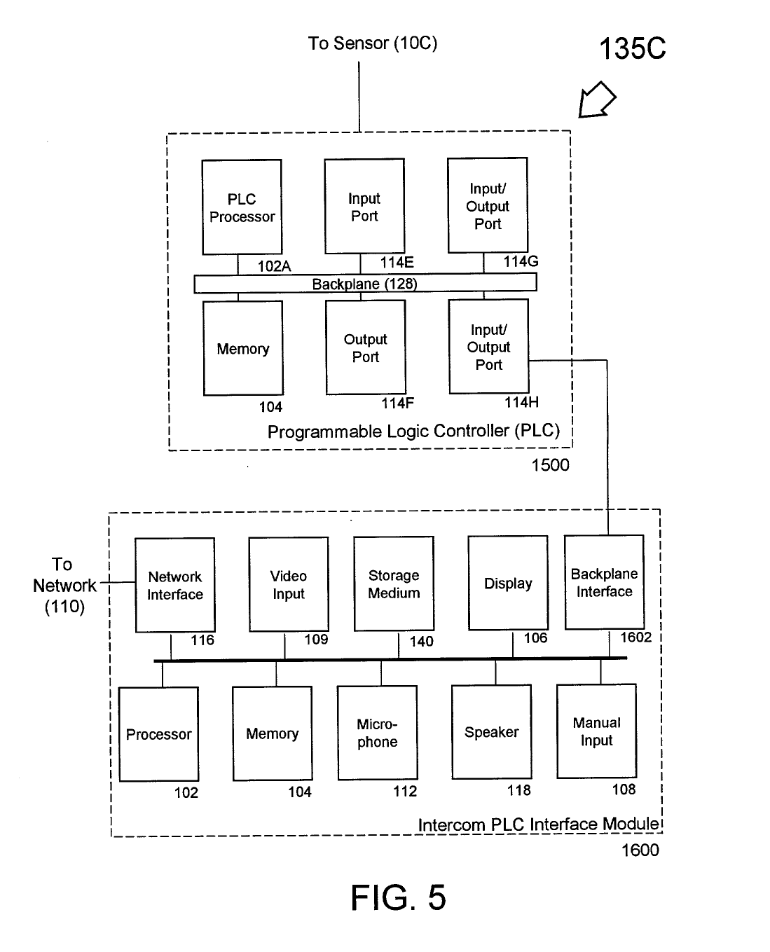

FIG. 5 depicts intercom device 135C, constructed and operative in accordance with an alternate embodiment of the present invention. It is understood that the use of a programmable logic controller 1500 in combination with an Intercom PLC interface module 1600 is just one example embodiment. In an embodiment where the intelligence is located on the Intercom PLC interface module 1600, intercom device 135 may comprise an Intercom PLC interface module 1600 combined with an input-output monitoring and device, programmable logic controller, or any other computing device.

Programmable logic controller 1500 comprises a PLC processor 102A, memory 104, and a series of input/output ports 114E-H coupled to a communications backplane 128.

Intercom PLC interface module 1600 may be coupled to the backplane 128 via an input/output port 114H, as shown, or be connected directly to the backplane 128. Intercom PLC interface module 1600 comprises a backplane interface 1602, network interface 116, microphone 112, speaker 118, and manual input 108. In other embodiments, intercom PLC interface module 1600 further comprises processor 102, memory 104, computer-readable storage medium 140, and video input 109.

As discussed above, it is understood that microphone 112 and speaker 118 may contain the appropriate analog-to-digital circuitry and analog-to-digital conversion circuitry as is known in the art. In some embodiments, microphone 112 and speaker 118 may be integrated into a single device.

Manual input 108 may be any button, keyboard, mouse, touch tablet or any other form of manual input as is known in the art.

Processor 102 may be any microprocessor or micro-controller as is known in the art. Additionally, Intercom PLC interface module 1600 may run a real time operating system, which may be embedded on storage medium 140. Additionally, software programming the processor 102 may also be found at computer-readable storage medium 140 or, alternatively, from another location across network 110.

Video input 109 may be any image capture device as is known in the art, such as a video camera. The use of intercom I/O interface modules 1400 will become clearer as described below.

Memory 104 may be any computer-readable memory as is known in the art, as discussed above.

Storage medium 140 may be any computer-readable storage as is known in the art, as discussed above.

Network interface 116 may be any interface as known in the art for communicating or transferring files across a computer network. A remote user using computer 120A may communicate with intercom device 135C via the network 110 and network interface 116.

Backplane interface 1602 allows Intercom PLC interface module 1600 to communicate with backplane 128, and thus monitor and control devices attached to programmable logic controller 1500. Backplane 128 signals include addressing, control, data, and power.

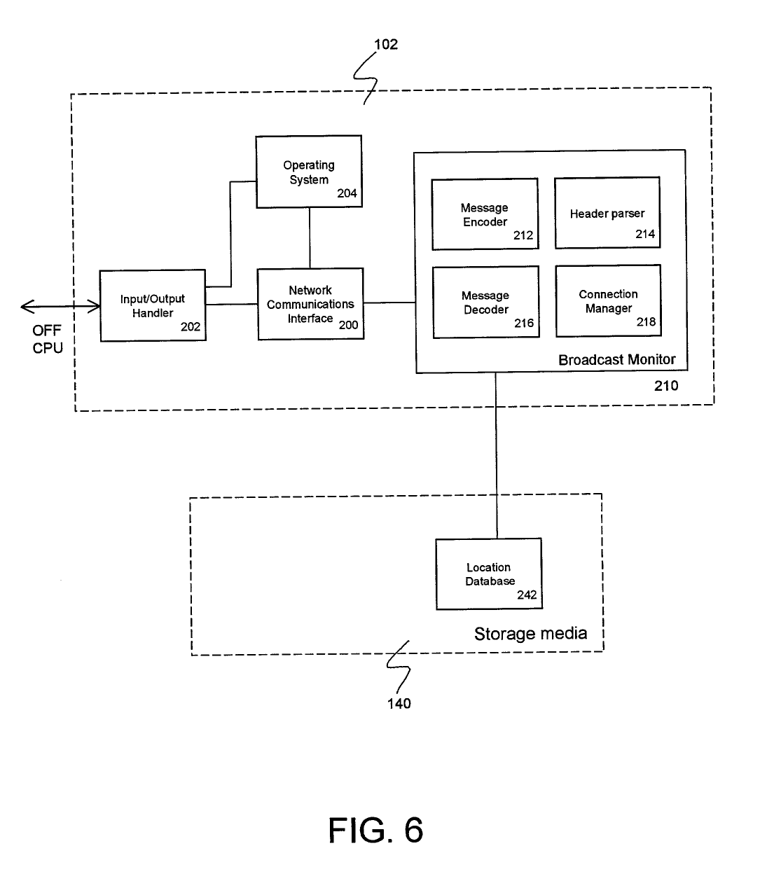

FIG. 6 is an expanded functional act diagram of processor 102 and storage medium 140, constructed and operative in accordance with an embodiment of the present invention. It is well understood by those in the art, that the functional act elements of FIG. 6 may be implemented in hardware, firmware, or as software instructions and data encoded on a computer-readable storage medium 140. Furthermore, it is understood that these structures may be implemented in conjunction with the embodiments described in FIGS. 1-5 above, or separately on their own. As shown in FIG. 6, central processing unit 102 comprises an input/output handler 202, an operating system 204, a network communications interface 200, and a broadcast monitor 210. In addition, as shown in FIG. 6, storage media 140 may also contain a location database 242.

Input/output handler 202 interfaces devices off the processor 102. In some embodiments, these devices include display 106, manual input device 108, video input 109, storage medium 140, speaker 118, microphone 112, input/output port 114, and network interface 116. The input/output handler 202 enables processor 102 to locate data on, read data from, and write data to, these components.

Operating system 204 enables processor 102 to take some action with respect to a separate software application or entity. For example, operating system 204 may take the form of a windowing user interface, as is commonly known in the art.

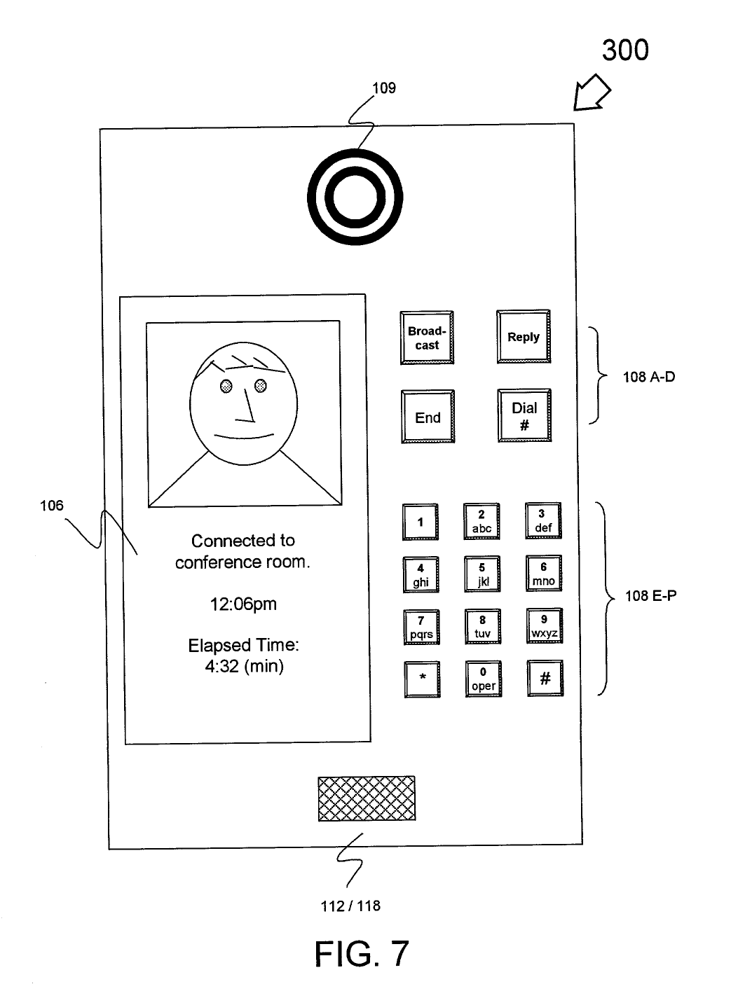

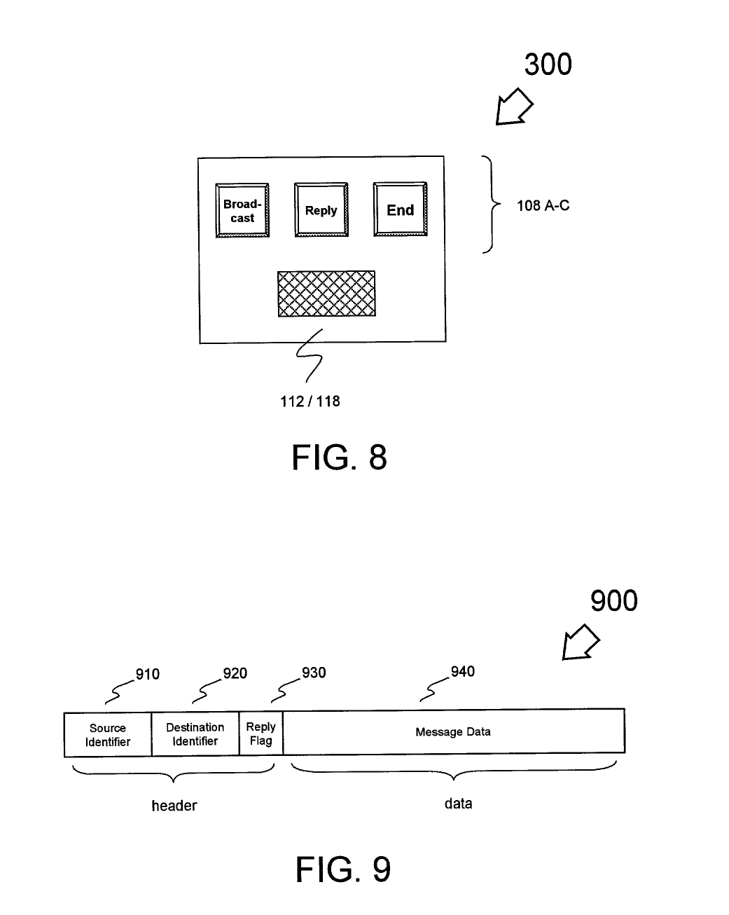

Network communications interface 200 is a user interface control program. In some embodiments, the network communications interface 200 may be stand-alone user interface program enabling the use of manual input buttons 108, or a graphical-user-interface window. Examples of two user interfaces 300 are described below in FIGS. 7 and 8.

Broadcast monitor 210 may further comprise a message encoder 212, a header parser 214, a message decoder 216, and a connection manager 218.

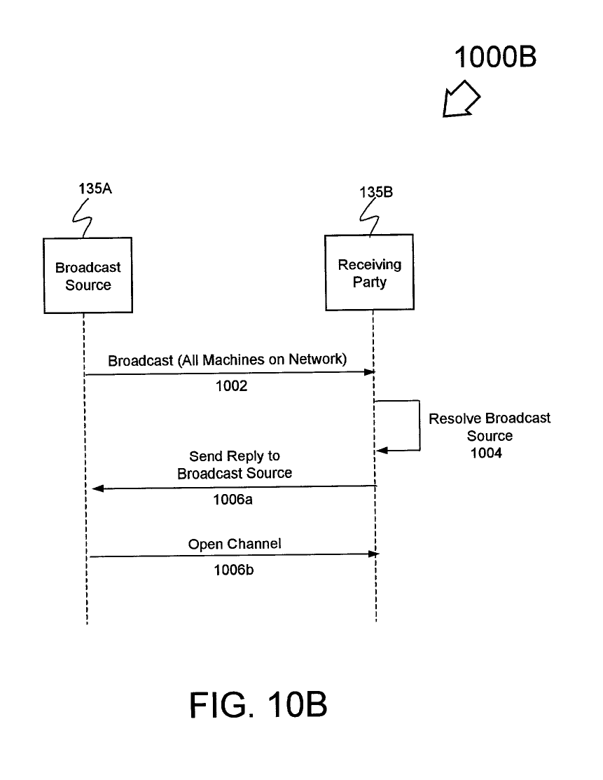

These components of broadcast monitor 210 interact with a location database 242, and may best be understood with respect to the sequence diagrams and flowcharts, FIGS. 10A, 10B, 11 and 12, as described below.

FIG. 7 illustrates a user interface 300 embodiment to facilitate the broadcast of audio/video signals, and to enable point-to-point communication with an intended recipient, constructed and operative in accordance with an embodiment of the present invention.

In one embodiment, user interface 300 comprises a combined speaker 118 and microphone 112, video camera 109, display 106, control buttons 108A-D, and numeric input buttons 108E-P.

The use of the user interface 300 embodiment is described in conjunction with the sequence diagram of FIG. 10A, constructed and operative in accordance with an embodiment of the present invention. It is understood that this combination is for illustrative purposes only, and that other sequences may equally apply without deviating from the spirit of the invention, defined only by the claims.

In such an embodiment, control buttons 108A-D are used to initiate and reply to an audio/video broadcast. Pressing broadcast button 108A initiates an audio/visual broadcast from broadcast source 135A to all other intercom devices 135 on network 110, sequence 1002. For example, a user may press broadcast button 108A and say, “James, are you there?” The audio information is captured by microphone 112, while video information is captured by a video camera 109. It is understood that the appropriate circuitry may digitize the audio/video information into packets.

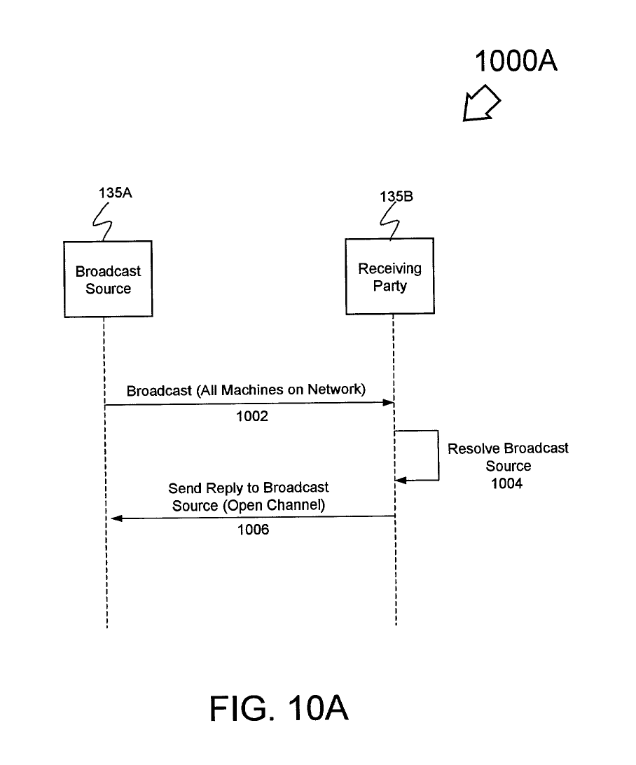

An example packet 900 is shown in FIG. 9, constructed and operative in accordance with an embodiment of the present invention. Packet 900 comprises header and message data 940. The header includes a source identifier 910, destination identifier 920, and a reply flag 930. Source identifier 910 is encoded with the network address of the broadcast source 135A, while destination identifier 920 is encoded with the destination network address. The network address may be encoded in any manner known in the art, such as internet protocol (IP) address or the like. When packet 900 is a broadcast packet, the broadcast address specifies that all machines on network 110 are to receive the packet. Reply flag 930 is a flag that helps intercom device 135 differentiate between a broadcast message and a reply. Reply flag 930 identifies whether the packet is a reply to a broadcast. A packet received by an intercom device 135 is a reply when the reply flag is marked “true.” As the broadcast is not a reply, initially the reply flag 930 is null or “false.” Message data 940 is a digitally encoded version of the audio/video information. In our example, message data 940 may store an audio broadcast of the phrase, “James, are you there?”

Returning to FIG. 10A, other intercom devices, including receiving party 135B, receive and play the broadcast audio/video information. To limit the broadcast to a particular network or sub-network (“sub-net”), a router or bridge 160, may selectively filter out broadcast packets. This may effectively limit the broadcast to other networks, such as the internet 110A.

An intended recipient hears the audio broadcast (“James, are you there?”), and responds by pressing reply button 108B at receiving party intercom device 135B. The receiving party 135B device resolves the broadcast source 135A at sequence 1004. In some embodiments, this may be accomplished through examining the source identifier 910 of the last broadcast packet received by receiving party intercom device 135B. In yet other embodiments, the network address stored in the source identifier 910 may be matched with a location stored in location database 242; the location can then be visually displayed on display 106.

A point-to-point reply can then be established by sending a reply to broadcast source, i.e., a channel is opened, at sequence 1006. The reply, such as “I'm here, Leonard,” may then be sent with a packet 900 encoded with the network address of the receiving party intercom device 135B in the source identifier 910, the broadcast source intercom device 135A in the destination identifier 920, and the reply flag 930 set to “one” or “true.”

The point-to-point connection between intercom devices 135A and 135B is maintained until the “End” button 108C is pressed at either intercom device.

In some embodiments, a broadcast only transmits audio information, but point-to-point connections transmit both audio and video information.

In yet other embodiments, a reply is sent to the broadcast source 135A, but it is the broadcast source 135A that then opens the point-to-point connection between the broadcast source 135A and the receiving party 135B. Such an embodiment is depicted in FIG. 10B, where sequence 1006 is broken into sequences 1006a and 1006b.

As shown, in some embodiments, numeric keypad buttons 108E-P may also be used to allow users to “dial” specific receiving party intercom devices 135 to initiate point-to-point communications in conjunction with the dial-number button 108D.

FIG. 8 illustrates an alternate embodiment of user interface 300 to facilitate the broadcast of audio signals, and to enable point-to-point communication with an intended recipient, constructed and operative in accordance with an embodiment of the present invention. In such an embodiment, user interface 300 comprises a combined speaker 118 and microphone 112, and control buttons 108A-C. The sequence of operation is similar to that of FIG. 7, although only audio messages are allowed in such an embodiment.

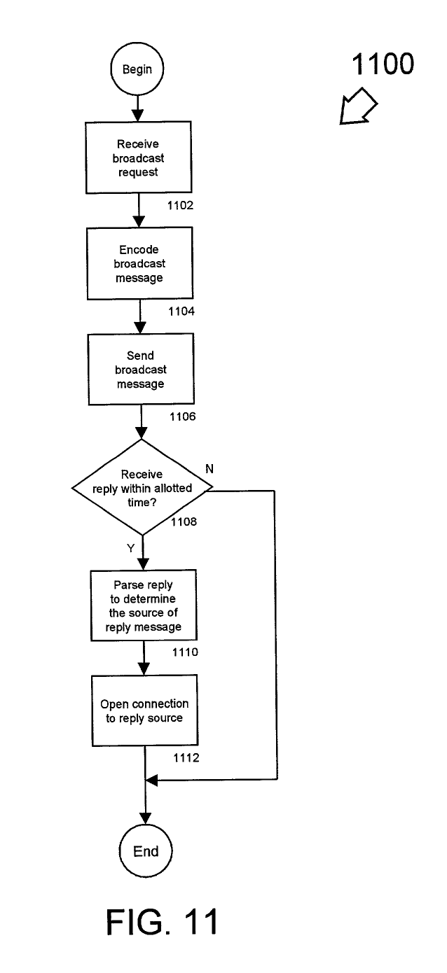

FIG. 11 flowcharts a broadcast party process 1100 to facilitate the broadcast of audio signals, and to enable point-to-point communication with an intended recipient, constructed and operative in accordance with an embodiment of the present invention.

Network communications interface 200 receives a broadcast request at block 1102 when the broadcast button 108A is pressed.

Message encoder 212 receives audio and/or video information from microphone 112 and video input 109, and packetizes or “encodes” the data into packets, block 1104. In some embodiments, the data may be digitally compressed by any compression algorithm known in the art able to compress data in real-time. Once the data is encoded, network interface 116 broadcasts the packet to other intercom devices 135 on the network 110 or sub-network, block 1106.

At decision block 1108, process 1100 waits to receive a reply to the broadcast within a pre-set allotted period of time. If no reply is received within the allotted time, it is assumed that the intended party does not receive the message, and the process 1100 ends.

However, if a packet is received and determined to be a reply message, as denoted by a “true” in the reply flag 930, as resolved by header parser 214, its source is determined at block 1110. In some embodiments, the determination is accomplished by parsing the header for the contents of the source identifier 910.

A point-to-point connection is then established between the broadcast source intercom device 135A and receiving party intercom device 135B, block 1112. The point-to-point connection may be established over network 110 by connection manager 218 through any means known in the art.

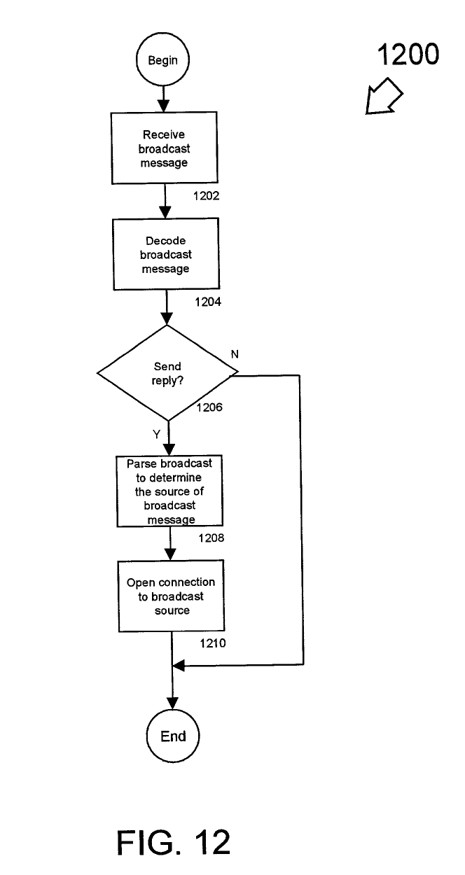

FIG. 12 flowcharts a receiving party process 1200 to receive the broadcast of audio signals, and to enable point-to-point communication with an intended recipient, constructed and operative in accordance with an embodiment of the present invention.

Network communications interface 200 receives a broadcast message via network interface 116 at block 1202. In some embodiments, a message can be identified as a broadcast message because the destination identifier 920 identifies the message as a broadcast, and/or the reply flag 930 is set to “false.”

Message decoder 216 receives audio and/or video information and plays the information at speaker 118 and display 106, block 1204. In some embodiments, that uses video or audio compression, the data may be digitally decompressed as part of the decoding. In some embodiments, only the audio message is voiced via speaker 118, and a visual alert, such as a flashing red screen, may be shown on display 106. In yet other embodiments without a display 106, only the audio message is voiced. In still yet other embodiments, header parser 214 may parse the network address of broadcast source intercom device 135A, and map the network address to a location database 242. In such embodiments, the visual alert may also display the location of the broadcast source intercom device 135A, such as “Conference Room,” as shown in FIG. 7.

At decision block 1206, process 1200 waits for reply message to be sent. The reply may be sent when the reply button 108B is pressed within a pre-set allotted period of time. If no reply is received within the allotted time, it is assumed that no reply is to be sent, and process 1200 ends.

However, if reply button 108B is pressed, the last broadcast message header is parsed to determine the network address of broadcast source intercom device 135A, block 1208. In some embodiments, the determination is accomplished by parsing the header for the contents of the source identifier 910.

A point-to-point connection may then established between the broadcast source intercom device 135A and receiving party intercom device 135B, block 1210. The point-to-point connection may be established over network 110 by connection manager 218 through any means known in the art.

The previous description of the embodiments is provided to enable any person skilled in the art to practice the invention. The various modifications to these embodiments will be readily apparent to those skilled in the art, and the generic principles defined herein may be applied to other embodiments without the use of inventive faculty. Thus, the present invention is not intended to be limited to the embodiments shown herein, but is to be accorded the widest scope consistent with the principles and novel features disclosed herein.

What is claimed is:

1. An apparatus comprising:
a network interface configured to broadcast a message on a network, to receive a reply from a receiving party, and to communicate with the receiving party through a point-to-point connection on the network.

2. The apparatus of claim 1, further comprising:
a message encoder, coupled to the network interface, configured to encode the broadcast message.

3. The apparatus of claim 2, further comprising:
a message decoder, coupled to the network interface, configured to decode the reply.

4. The apparatus of claim 3, wherein the reply is a point-to-point reply.

5. The apparatus of claim 4, wherein the reply is sent as a packet on the network.

6. The apparatus of claim 5, wherein the reply packet comprises a source identifier.

7. The apparatus of claim 6, further comprising:
a header parser, coupled to the message encoder, configured to identify the receiving party through examining the source identifier.

8. The apparatus of claim 7, wherein the reply flag identifies that a received communication as the reply.

9. The apparatus of claim 8, further comprising:
a backplane interface configured to couple to a backplane of a programmable logic controller.

10. A method comprising:
broadcasting a message on a network;
receiving a reply to the broadcast message from a receiving party;
opening a point-to-point connection with the receiving party.

11. The method of claim 10, wherein the broadcast message is sent as a packet on the network.

12. The method of claim 11, wherein the broadcast message comprises a source identifier.

13. A computer-readable medium encoded with data and instructions, the data and instructions causing an apparatus executing the instructions to:
broadcast a message on a network;
receive a reply to the broadcast message from a receiving party;
open a point-to-point connection with the receiving party.

14. The computer-readable medium of claim 13, wherein the broadcast message is sent as a packet on the network.

15. The computer-readable medium of claim 14, wherein the broadcast message comprises a source identifier.

16. An apparatus comprising:
means for broadcasting a message on a network;
means for receiving for a reply to the broadcast message from a receiving party;
means for opening a point-to-point connection with the receiving party.

17. The apparatus of claim 16, wherein the broadcast message is sent as a packet on the network.

18. The apparatus of claim 17, wherein the broadcast message comprises, and a source identifier.

19. The apparatus of claim 18, wherein a broadcast source is identified through the source identifier.

20. An apparatus comprising:
a header parser configured to identify a broadcast source of a broadcast message;
a network interface, coupled to the header parser, configured to receive the broadcast message from a network, and to send a point-to-point reply to the broadcast source.

21. The apparatus of claim 20, further comprising:
a message decoder, coupled to the network interface, configured to decode the broadcast message.

22. The apparatus of claim 21, further comprising:
a message encoder, coupled to the network interface, configured to encode the reply.

23. The apparatus of claim 22, wherein the reply is sent as a packet on the network.

24. The apparatus of claim 23, wherein the reply packet comprises a source identifier.

25. The apparatus of claim 24, further comprising:
a backplane interface configured to couple to a backplane of a programmable logic controller.

26. A method comprising:
receiving a broadcast message from a network;
identifying the broadcast source of the broadcast message;
sending a point-to-point reply to the broadcast source.

27. The method of claim 26, further comprising:
establishing a point-to-point connection to the broadcast source.

28. The method of claim 27, wherein the reply is sent as a packet on the network, the reply packet further comprising a reply flag and a source identifier.

29. The method of claim 28, wherein a network address of a replying party is embedded in the source identifier.

30. The method of claim 29, wherein the reply flag identifies the reply packet as the reply to the broadcast message.

31. A computer-readable medium encoded with data and instructions, the data and instructions causing an apparatus executing the instructions to:
receive a broadcast message from a network;
identify the broadcast source of the broadcast message; and
send a point-to-point reply to the broadcast source.

32. The computer-readable medium of claim 31, the data and instructions causing an apparatus executing the instructions to establish a point-to-point connection to the broadcast source.

33. The computer-readable medium of claim 32, wherein the reply is sent as a packet on the network, the reply packet further comprising a reply flag and a source identifier.

34. The computer-readable medium of claim 33, wherein a network address of a replying party is embedded in the source identifier.

35. The computer-readable medium of claim 34, wherein the reply flag identifies the communication as the reply to the broadcast message.

36. An apparatus comprising:
means for receiving a broadcast message from a network;
means for identifying the broadcast source of the broadcast message;
means for sending a point-to-point reply to the broadcast source.

37. The apparatus of claim 36, further comprising:
means for establishing a point-to-point connection to the broadcast source.

38. The apparatus of claim 37, wherein the reply is sent as a packet on the network, the reply packet further comprising a reply flag and a source identifier.

39. The apparatus of claim 38, wherein a network address of a replying party is embedded in the source identifier.

40. The apparatus of claim 39, wherein the reply flag identifies the reply packet as the reply to the broadcast message.

41. An apparatus comprising:
a message encoder, configured to encode a broadcast message;
a message decoder, coupled to the message encoder, configured to decode a reply to the broadcast message from a receiving party;
a connection manager, coupled to the message encoder, configured to communicate with the receiving party through a point-to-point connection on a network.

42. The apparatus of claim 41 wherein the apparatus is adapted to be coupled to an input/output port.

43. The apparatus of claim 42 wherein the input/output port is coupled to a backplane of a programmable logic controller.
